(19) United States
(12) Patent Application Publication
(10) Pub. No.: US 2009/0144585 A1
(43) Pub. Date: Jun. 4, 2009

(54) Debugging method of the basic input/output system

(76) Inventor: Ting-Chun Lu, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,686

(22) Filed: Dec. 4, 2007

(51) Int. Cl. G06F 11/14

(52) U.S. Cl. 714/36; 714/E11.211; 714/E11.178

(57) ABSTRACT

A debugging method of the BIOS is disclosed. Firstly a debugging routine is written into a boot program. Then the BIOS executes the boot program. The BIOS judges whether a status value is equal to a default value of the debugging routine or not. When the status value is equal to the default value, the BIOS outputs a test value according to the debugging routine. When the status value is not equal to the default value, the debugging routine is quit, and the BIOS continues to execute the boot program.

### BACKGROUND OF THE INVENTION

1. Field of the Invention

The present invention relates to a debugging method of the basic input/output system of a computer. In particular, this invention relates to a debugging method that utilizes the temperature variation or the output status of the general purpose input/output interface to debug the basic input/output system.

2. Description of the Related Art

The basic input/output system (BIOS) of a computer will read from and write to the random access memory (RAM) manufactured by CMOS. BIOS reads and writes CMOS to obtain the operation status of the computer, or to store user determined configuration values for the computer into the CMOS. The configuration values define the starting environment of the computer.

Generally, during the boot process, the boot program of the basic input/output system (BIOS) of the computer sends a specific code via an input/output (I/O) port address 80H periodically. The specific code is read by a debug monitoring card (port 80 card) connected to the input/output port address 80H. The debug monitoring card displays the specific code via LEDs. Thereby, the power-on self test (POST) is realized.

The POST enables the user to perform a simple debug when the computer is booted. However, a lot of problems may occur during the testing process of the BIOS. At this time, the designer needs to detect and debug the boot problems of the BIOS to solve the problems.

During the detecting and debugging stage of the BIOS, the engineer needs to set a detecting point in the boot program, and load the boot program into a BIOS chip. Then, the BIOS chip is plugged into the motherboard. When the boot program execution has reached the detecting point, the contents at the detection point is sent to the debug monitoring card via the input/output port address 80H. The engineer can perform a debugging judgment according to the contents of the detection point displayed by the debug monitoring card.

However, when the boot program execution has reached the detecting point, an endless loop is formed to output the contents of the detecting point. The boot program cannot quit from the detecting point to finish the boot program. Therefore, when the contents of the detecting point is obtained, the engineer needs to unplug the BIOS chip from the motherboard and load a boot program with a next detecting point into the BIOS chip. Then the BIOS chip is plugged into the motherboard again. By executing the updated boot program, the engineer can perform a debugging judgment according to the contents of the next detection point.

The traditional debugging method needs to repeatedly plug and unplug the BIOS chip located on the motherboard. It is time-consuming, and the detecting and debugging efficiency is low. Furthermore, because the BIOS chip is repeatedly plugged and unplugged, the connecting pins of the BIOS chip are easily damaged.

Alternatively, the detecting and debugging processes of the BIOS also can be implemented on an external machine. The machine can read the value of the register of the BIOS and execute an instruction pointer to quit the endless loop to finish the boot program. However, the debugging machine is expensive, and specific circuits and a connector on the motherboard are required. It is not an easy method for detecting and debugging the BIOS.

### SUMMARY OF THE INVENTION

One particular aspect of the present invention is to provide a debugging method of the basic input/output system which overcomes the above stated problems, such as excessive time-consumption and damage to hardware elements due to the BIOS chip has been repeatedly plugged and unplugged in the detecting and debugging processes. At the same time, the debugging method does not require additional expenses, and it is easy, rapid, and cheap.

The BIOS is located on a motherboard. The debugging method includes the following steps. Firstly a debugging routine is written into a boot program. Then the BIOS executes the boot program. The BIOS judges whether a status value is equal to a default value of the debugging routine or not. When the status value is equal to the default value, the BIOS outputs a test value according to the debugging routine. When the status value is not equal to the default value, the debugging routine is quit, and the BIOS continues to execute the boot program.

According to the above debugging method, two embodiments are used for judging whether the status value is equal to the default value of the debugging routine or not. In the first embodiment, a general purpose I/O (GPIO) interface is used for outputting the status value. In this case the default value of the debugging routine is “1” or “0”. In the second embodiment, a SURPERI/O chip is used to detect the temperature of the motherboard, and the temperature value is used as the status value. In this case the default value of the debugging routine is a temperature range.

The present invention utilizes the temperature variation or the output status of the GPIO interface to make the BIOS quit from the debugging routine and finish the boot program. After the computer is booted, the engineer can rewrite the debugging routine in the boot program, and directly update the boot program in the BIOS chip using a loading program. Therefore, by using the debugging method of the present invention to detect and debug the BIOS, repeated plugging and unplugging of the BIOS chip can be omitted. Thus no hardware elements are wasted and the time for detecting and debugging the BIOS is reduced.

For further understanding of the invention, reference is made to the following detailed description illustrating the embodiments and examples of the invention. The description is only for illustrating the invention and is not intended to limit the scope of the claims.

### BRIEF DESCRIPTION OF THE DRAWINGS

The drawings included herein provide a further understanding of the invention. A brief introduction of the drawings is as follows:

FIG. 1 is a schematic diagram of the computer being suitable for the debugging method of the present invention;

FIG. 2 is a flow chart of the debugging method of the BIOS of the first embodiment of the present invention; and

FIG. 3 is a flow chart of the debugging method of the BIOS of the second embodiment of the present invention.

### DETAILED DESCRIPTION OF THE PREFERRED EMBODIMENTS

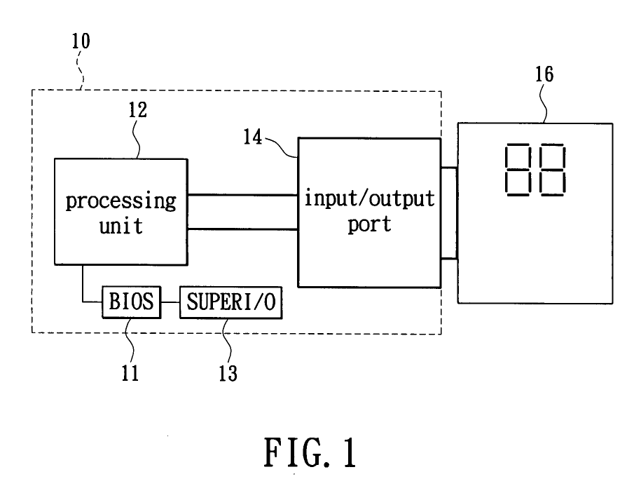

FIG. 1 is a schematic diagram of the computer being suitable for the debugging method of the present invention. The motherboard 10 has a BIOS chip 11, a SUPERI/O chip 13, a processing unit 12, and an input/output port 14. The above elements are integrated and electrically connected to the motherboard 10. Furthermore, the input/output port 14 is connected with a testing card 16. The input/output port 14 has an input/output port address 80H (not labeled), and is used as a system debugging port.

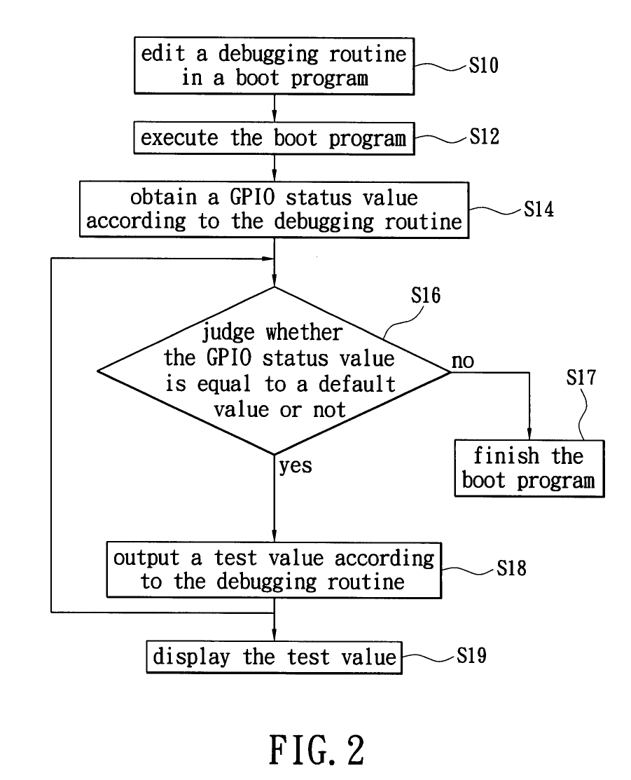

Reference is made to FIGS. 1 and 2. FIG. 2 is a flow chart of the debugging method of the BIOS of the first embodiment of the present invention. Firstly, a debugging routine is edited in a boot program (S10). Next, the BIOS executes the boot program with the debugging routine (S12). The BIOS executes the debugging routine and obtains a GPIO status value from the GPIO interface according to the debugging routine (S14). The BIOS judges whether the GPIO status value is equal to a default value of the debugging routine or not (S16). When the GPIO status value is equal to the default value, the BIOS outputs a test value according to the debugging routine (S18). When the status value is not equal to the default value, the BIOS quits the debugging routine, and the process returns to step S12 to continue executing the boot program, or quits the detecting routine to finish the boot program (S17).

Reference is made to FIG. 2 again. After step S18 is performed, the test value is sent to the testing card 16 via the input/output port address 80H of the motherboard 10 and is displayed (S19). The testing card 16 can be a seven-segment display. After step S18, the BIOS continuously judges whether the status value is equal to the default value (S16). When the GPIO status value is equal to the default value, step S18 is performed. When the GPIO status value is different from the default value, step S17 is performed.

Reference is made to FIG. 2 again. Steps 14 to 18 are the debugging routine. According to the debugging routine, The BIOS obtains the status value of the GPIO. The status value of the GPIO is logic “1” or “0”. The BIOS judges whether the status value of the GPIO matches the default value (logic “1” or “0”) or not. When both are matched, the BIOS outputs the test value. When the status value of the GPIO does not match the default value set in the debugging routine, the BIOS quits the debugging routine, and continues to execute the boot program.

In step S14, the GPIO interface is connected with a general input/output button so that the user can control the general input/output button to be turned on or turned off to change the status value of GPIO and output the status value of GPIO to the GPIO interface.

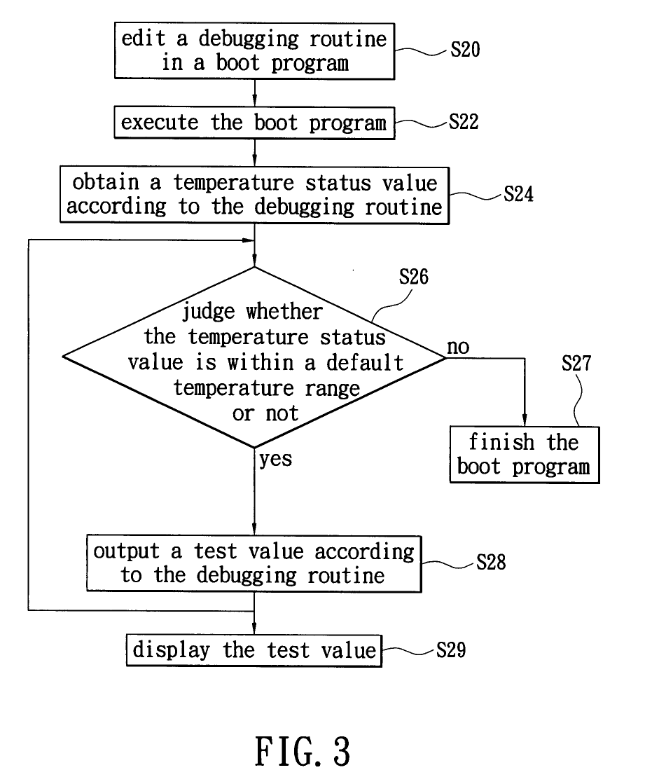

Reference is made to FIGS. 1 and 3. FIG. 3 is a flow chart of the debugging method of the BIOS of the second embodiment of the present invention. Firstly, a debugging routine is edited in a boot program (S20). Next, the BIOS executes the boot program with the debugging routine (S22). The BIOS executes the debugging routine and obtains a temperature status value of the motherboard 10 from a SUPERI/O chip 13 according to the debugging routine (S24). The BIOS judges whether the temperature status value is within a default temperature range of the debugging routine or not (S26). When the temperature status value is within the default temperature range, the BIOS outputs a test value according to the debugging routine (S28). When the temperature status value is not within the default temperature range, the BIOS quits the debugging routine, and the process returns to step S22 to continue executing the boot program, or quits the detecting routine to finish the boot program (S27).

Reference is made to FIG. 3 again. After step S28 is performed, the test value is sent to the testing card 16 via the input/output port address 80H of the motherboard 10 and is displayed. The testing card 16 can be a seven-segment display. After step S28, the BIOS continuously judges whether the temperature status value is within the default temperature range (S26). When the temperature status value is within the default temperature range again, step S28 is performed. When the temperature status value is not within the default temperature range, step S27 is performed.

Reference is made to FIG. 3 again. Steps 24 to 28 are the debugging process. According to the debugging routine, the BIOS obtains the temperature status value of the motherboard 10. The temperature status value is an analog value. The debugging routine judges whether the temperature status value is within the default temperature range or not. When the temperature status value is within the default temperature range, the BIOS outputs the test value, and continuously judges whether the temperature status value of the motherboard 10 is within the default temperature range or not. When the temperature status value of the motherboard 10 is not within the default temperature range, the BIOS quits the debugging routine, and continues to execute the boot program.

In step S24, the temperature status value can be the temperature of one element of the motherboard 10. In this embodiment, The CPU on motherboard 10 is used as an example. The user can install or uninstall the heat sink of the CPU on the motherboard 10 to change the temperature status value.

The present invention utilizes the temperature variation or the output status of the GPIO interface to make the BIOS quit from the debugging routine and finish the boot program. After the computer is booted, the engineer can reset the debugging routine in the boot program, and directly update the boot program into the BIOS chip by using a loading program.

Therefore, by using the debugging method of the present invention to detect and debug the BIOS, the repeated plugging and unplugging of the BIOS chip can be omitted. Thus no hardware elements are wasted and the time for detecting and debugging the BIOS is reduced. The debugging method of the basic input/output system of the present invention can thus overcome problems of the prior art, such as excessive time-consumption and damage to hardware elements. At the same time, the debugging method does not need additional expenses, and it is easy, rapid, and cheap.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A debugging method of a basic input/output system (BIOS), the BIOS being located on a motherboard, comprising:
editing a debugging routine in a boot program;
executing the boot program by the BIOS;
judging whether a status value is equal to a default value of the debugging routine or not;
when the status value is equal to the default value, the BIOS outputs a test value according to the debugging routine; and
when the status value is not equal to the default value, the debugging routine is quit, and the BIOS continues to execute the boot program.

2. The debugging method of a basic input/output system as claimed in claim 1, wherein the status value is a general purpose I/O (GPIO) status value outputted from a GPIO interface.

3. The debugging method of a basic input/output system as claimed in claim 1, further comprising a step of displaying the test value after the step of outputting the test value.

4. The debugging method of a basic input/output system as claimed in claim 3, wherein the test value is outputted to a testing card via an input/output port address 80H on the motherboard, and then is displayed.

5. The debugging method of a basic input/output system as claimed in claim 1, wherein after the step of outputting the test value by the BIOS, the BIOS continuously judges whether the status value is equal to the default value or not.

6. The debugging method of a basic input/output system as claimed in claim 5, wherein the step of outputting the test value by the BIOS is repeated when the status value matches the default value.

7. The debugging method of a basic input/output system as claimed in claim 5, wherein the BIOS quits the debugging routine and continues to execute the boot program when the status value does not match the default value.

8. The debugging method of a basic input/output system as claimed in claim 1, wherein the status value is a temperature status value, the temperature status value being the temperature of the motherboard detected by a SUPERI/O chip.

9. The debugging method of a basic input/output system as claimed in claim 8, wherein the default value is a temperature range.

10. The debugging method of a basic input/output system as claimed in claim 9, further comprising a step of displaying the test value after the step of outputting the test value.

11. The debugging method of a basic input/output system as claimed in claim 10, wherein the test value is outputted to a testing card via an input/output port address 80H on the motherboard, and then is displayed.

12. The debugging method of a basic input/output system as claimed in claim 10, wherein after the step of outputting the test value by the BIOS, the BIOS continuously judges whether the temperature status value is within the temperature range or not.

13. The debugging method of a basic input/output system as claimed in claim 12, wherein the step of outputting the test value by the BIOS is repeated when the temperature status value is within the temperature range.

14. The debugging method of a basic input/output system as claimed in claim 12, wherein the BIOS quits the debugging routine and continues to execute the boot program when the temperature status value is not within the temperature range.
